(19) United States
(12) Patent Application Publication
(10) Pub. No.: US 2026/0119293 A1
(43) Pub. Date: Apr. 30, 2026

(54) ASSET ANOMALY DETECTION USING CLUSTERING WITH FEEDBACK

(71) Applicant: Honeywell International Inc., Charlotte, NC (US)

(72) Inventors: Feng Xie, Hangzhou (CN); Qing Shuang Zeng, Shanghai (CN); Erick Li, Shanghai (CN); Lei Xie, Shanghai (CN)

(21) Appl. No.: 18/926,621

(22) Filed: Oct. 25, 2024

(51) Int. Cl. G06F 11/07

(52) U.S. Cl. CPC G06F 11/0751

(57) ABSTRACT

Devices, methods, and systems for asset anomaly detection using clustering with feedback are described herein. One method includes receiving, by a computing device, sample data including a plurality of data points associated with an asset, generating, by the computing device, a plurality of clusters based on the received sample data according to a plurality of operational conditions associated with the asset, determining, by the computing device, a confidence level associated with each data point within each cluster of the plurality of clusters, displaying, by a user interface of the computing device, the plurality of clusters and each data point having a determined confidence level below a predefined threshold, receiving, via the user interface of the computing device, approval of the plurality of clusters, and storing, by the computing device, the plurality of clusters in a database upon receiving approval from a user.

### TECHNICAL FIELD

The present disclosure relates generally to devices, methods, and systems for asset anomaly detection using clustering with feedback.

### BACKGROUND

Machine learning models are widely used in asset anomaly detection and prediction and root cause analysis. Building machine learning models requires training with meaningful datasets in order to produce accurate prediction models. Training datasets can be created by identifying normal operational condition data from historical data. However, this process is often a manual operation and can be very tedious. Due to the number of process variables, length of the data, and/or resolution of a computer monitor, one may need to immerse themselves into the historical data, spend hours (or days) zooming in and out, scrolling left and right to select the training dataset, and/or perform multiple trial and error trainings/validations in order to produce a training model with adequate performance. Current methods may also utilize clustering techniques to identify operational conditions within asset data and detect anomalous data associated with the asset using trained models based on identified normal behavior. However, historical data oftentimes contains multiple operational conditions such that an asset may be clustered into different clusters or scattered among various clusters, producing inaccurate results.

### BRIEF DESCRIPTION OF THE DRAWINGS

FIG. 1 illustrates an example system for asset anomaly detection using clustering with feedback in accordance with one or more embodiments.

FIG. 2 illustrates a flow diagram of an example method for asset anomaly detection using clustering with feedback in accordance with one or more embodiments.

FIG. 3 illustrates a conceptual example of operations related to asset anomaly detection using clustering with feedback in accordance with one or more embodiments.

FIG. 4 illustrates a flow diagram of an example method for training a model using a result of clustered asset data with feedback in accordance with one or more embodiments.

FIG. 5 illustrates a flow diagram of an example method for operating a trained model using a result of clustered asset data with feedback in accordance with one or more embodiments.

FIG. 6 illustrates a block diagram of an example computing device for asset anomaly detection using clustering with feedback in accordance with one or more embodiments.

### DETAILED DESCRIPTION

Devices, methods, and systems for asset anomaly detection using clustering with feedback are described herein. One method includes receiving, by a computing device, sample data including a plurality of data points associated with an asset, generating, by the computing device, a plurality of clusters based on the received sample data according to a plurality of operational conditions associated with the asset, determining, by the computing device, a confidence level associated with each data point within each cluster of the plurality of clusters, displaying, by a user interface of the computing device, the plurality of clusters and each data point having a determined confidence level below a predefined threshold, receiving, via the user interface of the computing device, approval of the plurality of clusters, and storing, by the computing device, the plurality of clusters in a database upon receiving approval from a user.

The present disclosure improves asset anomaly detection by identifying normal operational conditions from historical data with user feedback. Training techniques for machine learning models can utilize the data identifying the normal operational conditions to build machine learning models for anomaly detection with improved accuracy and in a quicker and/or easier manner than previous manual training approaches.

As an example, sample data may be collected from one or more sensor devices (e.g., temperature sensor, pressure sensor, flow sensor, fluid level sensor) associated with an asset. The sample data can include time series data sampled at certain time intervals and/or within a particular time period. The sample data may be stored in a memory device or a database.

An example method can begin with receiving the sample data for an asset, and generating a plurality of clusters based on the received sample data according to a plurality of operational conditions associated with the asset. For example, a determination can be made as to whether the received sample data includes user feedback (e.g., labels) on all data points of the sample data. If all of the data points are not labeled, the sample data can be clustered without receiving user feedback (e.g. using density-based methods, K-means, etc.). If some of the data points are labeled via user feedback (e.g., indicating the data points belong to specified operational conditions, anomalies, or noise), then the sample data can undergo further clustering. In this process, the previously unlabeled data can be clustered and labeled according to the operational conditions, and the previously labeled data can be refined further. For example, refining the labeled datasets can include excluding data points labeled as noise or anomalies in order to fine tune the clustered data. For instance, it can be determined whether the sample data includes any data points included in a previously generated cluster, and these data points can be excluded when generating the subsequent clusters. Further, in some examples, the clusters can be generated based on transitional conditions associated with the asset (e.g., data points collected during a period when the asset is transitioning between operational conditions).

The results of all cluster operations (e.g., the generated plurality of clusters) may be presented to a user (e.g., subject matter expert) who is familiar with the asset, along with a calculated confidence level for each data point within each cluster. The confidence level may be determined for each data point in a cluster to represent the certainty of that data point being included in that specific cluster. For example, the confidence level may be represented by a value that represents the distance from the center of the cluster. Data points in a specified cluster can be displayed to a user in order of confidence level from low to high, as an example.

Related data points can be retrieved and displayed alongside the clustered data. For example, data points within a specified time frame around a specific data point along with other recorded information (e.g., alarm events, actions performed by an operator) can be retrieved from the memory device or database to present the user with a complete view of the data point of interest. This process can be useful for data points with low/no confidence level applied in order for the user to determine how to accurately label the data point.

If the results of the clustering operations are acceptable to a user (e.g., all normal operational conditions have been accurately clustered), then the user can submit their approval and the clustering results can be saved to a database to be used in later training methods for machine learning models. If the results of the clustering operations are not acceptable to a user (e.g., some data points have low/no confidence level assigned), then the user may label the data points appropriately, and the sample data can repeat the clustering process until the results are acceptable.

To train a machine learning model (e.g., autoencoder model) for anomaly detection, data of normal operational conditions identified from the clustering process can be received and processed by a neural network training model. The neural network training model can include an encoder and decoder to determine appropriate weights and biases for the model based on the training dataset. The output of the decoder may be referred to as reconstructed data. The difference between the reconstructed data and the original data (e.g., the initial data entering the neural network) may be calculated to determine a reconstruction error. If the reconstruction error is within a suitable margin (e.g., the difference between the reconstruction error of the current iteration and the previous iteration of the model is below a predefined threshold), then the training is completed. If the reconstruction error is determined to be outside the suitable margin, then another iteration is performed after adjusting the neural network parameters.

The trained neural network model can then be used for anomaly detection by utilizing the learned key data features from the defined normal operational conditions. Real-time data corresponding to an asset can be received at the trained model. The data can be encoded and decoded in the trained model to generate reconstructed data. The reconstruction error can be determined by comparing the original pre-processed data with the reconstructed data. If the reconstruction error is larger than a predefined threshold, an anomaly flag can be set to indicate the asset includes an error. If the reconstruction error is within the threshold, the operation will return to process the real-time data at the next time interval.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

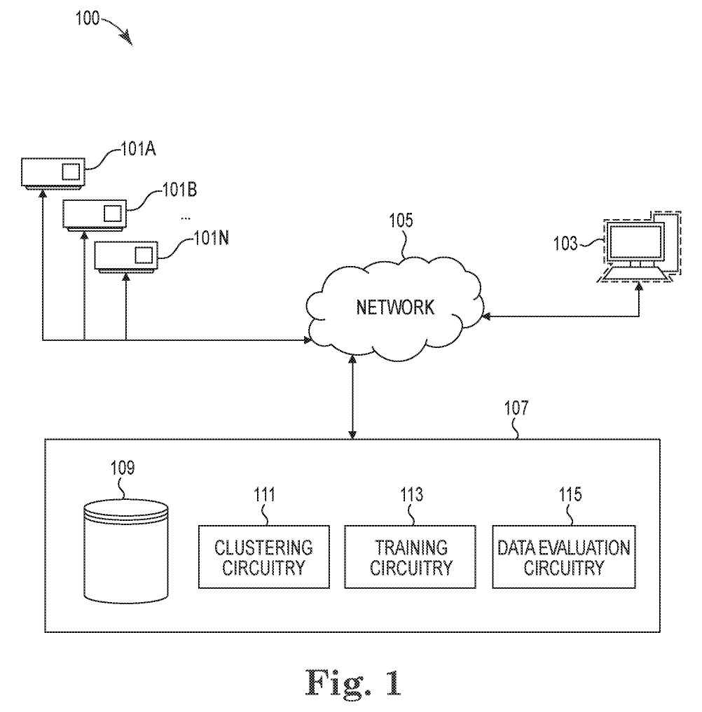

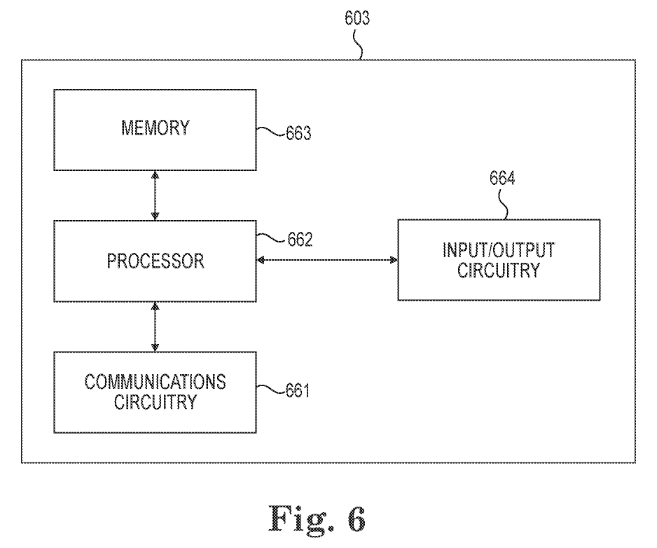

The figures herein follow a numbering convention in which the first digit or digits correspond to the drawing figure number and the remaining digits identify an element or component in the drawing. Similar elements or components between different figures may be identified by the use of similar digits. For example, 103 may reference element “03” in FIG. 1, and a similar element may be referenced as 603 in FIG. 6.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designator “N”, as used herein, particularly with respect to reference numerals in the drawings, indicates that a number of the particular feature so designated can be included with a number of embodiments of the present disclosure.

FIG. 1 illustrates an example system 100 for asset anomaly detection using clustering with feedback in accordance with one or more embodiments. The system 100 can include a plurality of assets 101A, 101B, …, 101N (which may collectively be referred to as assets 101). As used herein, an asset may refer to any device, equipment, machine, or property owned and/or utilized by a particular person or entity. For example, real-time data of asset 101A may indicate a potential fault, failure, or other problem with asset 101A is ocurring. By analyzing the data from asset 101A, anomalies may be discovered that correlate to assets 101B, …, 101N or other assets with similar characteristics.

The system 100 can include assets 101, network 105, diagnostic system 107, and a computing device 103. The computing device 103 may be a computing device that can be overseen by an administrator, data engineer, or other subject matter expert associated with asset management. The computing device 103 may receive data associated with any one of the assets 101 via network 105. As used herein, the network may also be referred to as a server in a cloud computing infrastructure or environment.

Network 105 can be a network relationship through which assets 101, diagnostic system 107, and computing device 103 can communicate. Examples of such a network relationship can include a distributed computing environment (e.g., a cloud computing environment), a wide area network (WAN) such as the Internet or a LoRaWAN, a local area network (LAN), a personal area network (PAN), a campus area network (CAN), or metropolitan area network (MAN), among other types of network relationships. For instance, network 105 can include a number of servers that receive information from, and transmit information to, assets 101, diagnostic system 107, and computing device 103 via a wired or wireless network.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices, such as computing device 103, together to form a distributed control network (e.g., cloud).

A network may provide connections to the Internet and/or to the networks of other entities (e.g., organizations, institutions, etc.). Users (e.g., tenants) may interact with network-enabled software applications to make a network request, such as to get a file or print on a network printer. Applications may also communicate with network management software, which can interact with network hardware to transmit information between devices on the network.

In some embodiments, diagnostic system 107 is configured to interact with computing device 103. The computing device 103 can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that device. Further, while a single computing device is illustrated, the term “computing device” shall also be taken to include any collection of computing devices that individually or jointly execute a set (or multiple sets) of instructions to perform any one or more of the methodologies discussed herein.

In alternative embodiments, the computing device 103 can be connected (e.g., networked) to other computing devices in a LAN, an intranet, an extranet, and/or the Internet. The computing device 103 can operate in the capacity of a server or a client device in client-server network environment, as a peer device in a peer-to-peer (or distributed) network environment, or as a server or a client device in a cloud computing infrastructure or environment.

The computing device may store an application in memory configured to perform the asset management method described herein. The computing device 103 may also include a processor that may be configured to retrieve and execute instructions associated with the application stored in memory.

In some embodiments, diagnostic system 107 is configured to receive, generate, and cause transmission of data, such as one or more indications of potential faults of one or more assets, to computing device 103. In some embodiments, the diagnostic system 107 is configured to receive data associated with one or more assets 101 A-101 N. In some embodiments, the received data refers to data obtained by recording readings of one or more sensor devices configured to monitor one or more assets 101 (e.g., a boiler, compressor, system, and/or other type of equipment or device). Examples of sensor devices whose readings are used to generate such data can include pressure (e.g., water pressure, air pressure, etc.) sensor devices, temperature sensor devices, motion sensor devices, environmental sensor devices, fan angular motion sensor devices, cameras, audio recorders, and/or the like. As one example, an asset such as a compressor may be associated with sensor devices monitoring data of the compressor. In this regard, example sensor devices that monitor data of the compressor may include a discharge temperature sensor, a discharge pressure sensor, a flow sensor, a suction drum level sensor, a suction temperature sensor, a suction pressure sensor, a control valve output sensor, a motor current sensor, a speed sensor, a motor temperature sensor, and/or the like. The diagnostic system 107 may communicate with computing device 103, assets 101, and other associated devices through network 105.

As illustrated in FIG. 1, diagnostic system 107 can include a storage subsystem (e.g., database) 109. In some embodiments, the storage subsystem 109 may be configured to store received data as well as one or more machine learning models (e.g., an autoencoder model) and data associated with the one or more machine learning models utilized by the diagnostic system 107, such as stored historical data. The storage subsystem 109 may include one or more storage units, such as multiple distributed storage units that are connected through a computer network. Each storage unit in the storage subsystem 109 may store one or more data assets or one or more data associated with assets 101. Storage subsystem 109 can be any type of storage medium that can be accessed by computing device 103 to perform various examples of the present disclosure. For example, storage subsystem 109 can be a non-transitory computer readable medium having computer readable instructions (e.g., executable instructions/computer program instructions) stored thereon that are executable by a processor for asset management in accordance with the present disclosure. The storage subsystem 109 may include volatile or nonvolatile memory.

As illustrated in FIG. 1, the diagnostic system 107 can comprise clustering circuitry 111 in some embodiments. The clustering circuitry 111 can include one or more predefined functions, algorithms and/or instructions for performing asset anomaly detection or clustering on received sample data, such as for clustering data into one or more data clusters, determining a normal operational condition associated with the received sample data, and/or the like.

The diagnostic system 107 can include training circuitry 113 in some embodiments. The training circuitry 113 can include one or more predefined functions and/or instructions for processing clustered data to train a model, such as an autoencoder model, based at least on clustered data determined by the clustering circuitry 111, and/or the like.

The diagnostic system 107 can include data evaluation circuitry 116 in some embodiments. The data evaluation circuitry 115 can comprise one or more predefined functions and/or commands for processing a plurality of data in accordance with a trained model, such as a trained autoencoder model to generate output data, and/or the like.

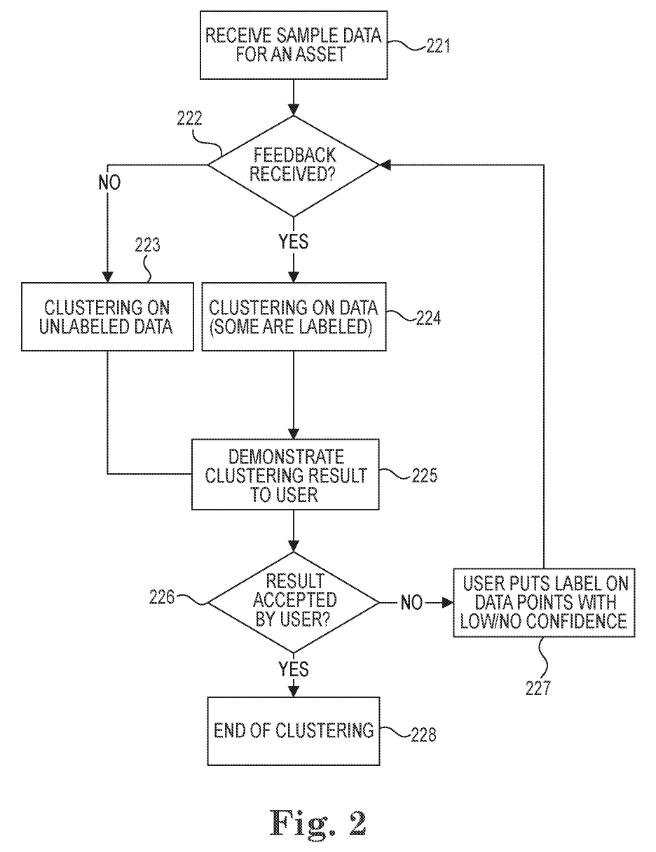

FIG. 2 illustrates a flow diagram of an example method for asset anomaly detection using clustering with feedback in accordance with one or more embodiments. The method illustrated in FIG. 2 may be performed by diagnostic system 107 and/or computing device 103, as described in connection with FIG. 1.

At operation 221, the diagnostic system 107, such as storage subsystem 109, clustering circuitry 111, and/or data evaluation circuitry 115 may receive sample data for an asset. The sample data may be associated with one or more assets 101. The sample data can be received or otherwise accessed from a variety of sources. For example, the sample data may be received (e.g., via network 105) from one or more sensor devices associated with the asset, such as temperature sensor devices, pressure sensor devices, oxygen sensor devices, and/or other types of sensor devices. In some examples, sample data may be received from an intermediary device between the sensor devices and the diagnostic system 107, such as a computing device associated with and/or embodied by the asset that is configured to monitor and/or control related sensor devices. In some examples, rather than being directly received from a source such as the asset, sensor device(s), and/or computing devices associated with the asset, the sample data may be received in an indirect manner, such as by way of computing device 103. In this regard, the sample data may be collected and processed, such as by a data engineer or the like, prior to being provided to the diagnostic system 107 for clustering.

The sample data may include data (e.g., a plurality of data points) associated with an asset 101. As an example, the sample data may include historical data associated with one or more assets 101. The historical data may include multiple operational conditions. As used herein, an operational condition is a condition in which the associated asset is operating under, such as a setting or configuration for example. The operational condition(s) may be predefined by a user in some examples. Alternatively, the operational condition(s) may be unknown at the start of the clustering process and may be derived as part of the clustering process.

The sample data may include indications of process variables having values determined by sensors associated with the asset. For example, the sample data may include temperature readings, gas level readings, pressure level readings, speed, and/or flow rate readings associated with the asset 101.

The sample data may include time series data (e.g., a series of data points indexed according to time) sampled at a certain time interval. For example, the sample data may be data captured from one or more sensors associated with the asset over a specific period of time and at a particular sampling rate. As one non-limiting example, the sample data may comprise data captured from the one or more sensors every 10 minutes over a 48 hour period. As another non-limiting example, the sample data may include a large data set, such as three years of data related to a number of process variables.

The sample data may include an identifier relating the sample data to the asset it was received from. The identifier may be embedded within the sampled data (e.g., as a string of bits) to facilitate the identification of the asset and an associated operational condition. The identifier may include a description of the asset, historical maintenance of the asset, and/or one or more settings associated with the asset.

At operation 222, the method determines whether feedback has been received for the received sample data. The feedback may include labels on individual data points within the received sample data or labels on entire datasets. The labels may indicate which cluster the sample data belongs to, an operational condition associated with the sample data, whether the sample data includes an anomaly, or a transitional condition associated with the sample data. A transitional condition may refer to a data point that is collected during a period when the asset is transitioning between operational conditions.

The feedback may be received from a user of computing device 103 described in connection with FIG. 1. For example, a user of computing device 103, such as a subject matter expert in the maintenance and functioning of assets 101, may label each data point within the received sample data according to a condition associated with the data point.

Operation 222 includes determining whether feedback was received (e.g., labels applied) for each data point in the sample data. If feedback was not received for any of the data points within the received sample data, then the method proceeds to operation 223. If feedback has been received for some data points, but not all of the data points included in the sample data, then the method proceeds to operation 224.

At operation 223, clustering is performed on the unlabeled data (e.g., feedback was not received). More than one clustering method may be applied to the sample data. In some examples, the sample data can be automatically clustered in an unsupervised manner, such as by applying density-based clustering to process variables of the received sample data. By applying density-based clustering to the received sample data, clusters are defined as areas of a higher density of data points than the remainder of the data set, and a number of clusters can be automatically identified based on the density of data distribution. In this regard, data points within clusters are considered to represent normal operational conditions and/or behavior of the asset, or non-fault states, whereas outlier data points in sparse areas may be considered to be anomalous data, or representative of a fault state. It is to be appreciated that methods other than density-based clustering may be performed, such as, for example, K-Means clustering, agglomerative clustering, mean-shift clustering, spectral clustering, and/or the like.

At operation 224, clustering is performed on the received sample data in which some data points have been previously labeled (e.g., feedback was received). More than one clustering method may be applied to the sample data. In some examples, the sample data can be automatically clustered in an unsupervised manner, such as by applying density-based clustering to process variables of the received sample data. By applying density-based clustering to the received sample data, clusters are defined as areas of a higher density of data points than the remainder of the data set, and a number of clusters can be automatically identified based on the density of data distribution. In this regard, data points within clusters are considered to represent normal operational conditions and/or behavior of the asset, or non-fault states, whereas outlier data points in sparse areas may be considered to be anomalous data, or representative of a fault state. It is to be appreciated that methods other than density-based clustering may be performed, such as, for example, K-Means clustering, agglomerative clustering, mean-shift clustering, spectral clustering, and/or the like.

After the received sample data has been clustered at operations 223 or 224, the resulting clustered data is displayed (e.g., demonstrated) to a user at operation 225. The clustered data may include normal operational conditions of the asset(s) associated with the received sample data. Normal operational conditions may indicate a typical behavior of the asset. The clustered data may be demonstrated to one or more users of computing device 103 via a display of computing device 103.

At operation 226, the method determines whether the clustering results are accepted by the user. The user may analyze the clustered data and the associated labels applied to the clustered data. For example, some data points within the clustered data may be labeled as anomalous, noise, or included within a transitional period. The clustered data may include one or more clusters corresponding to an operational condition associated with the one or more assets.

For each data point in a cluster among the plurality of clusters, a confidence level is determined. The confidence level may be determined for each data point in a cluster to represent the certainty of that data point being included in that specific cluster. For example, the confidence level may be represented by a value that represents the distance from the center of the cluster. Data points in a specified cluster can be displayed to a user in order of confidence level from low to high, as an example. There may be some data points that do not belong to a cluster as a result of the clustering process. These data points will have no confidence level attached.

As part of operation 226, a user can retrieve other data points from within a time period around a specific data point of interest along with other recorded information (e.g., alarm events, operator actions, etc.) from the storage subsystem 109. As an example, data collected within 10 minutes of the data point of interest may be retrieved to aid a user in identifying whether the data point of interest is an outlier, an anomaly, noise, or belongs to a specific cluster. The data point of interest may be a data point with low/no confidence level associated.

If a user determines that the clustering results are acceptable (e.g., the sample data has been clustered appropriately and each data point has been assigned to the correct cluster according to the normal operational conditions), then the method proceeds to operation 228 and the clustering process is complete. The clustering results are stored (e.g., in database 109 of FIG. 1) for future training of machine learning models. If the clustering results are not acceptable to a user (e.g., clusters do not define normal operational conditions, some data points still have low/no confidence level associated), then the method proceeds to operation 227 in which the user puts labels on data points with low or no confidence level.

At operation 227, a user labels the data points with low or no confidence level by examining data points collected within a certain time period of the data points of interest. As an example, data collected within 10 minutes of the data point of interest may be retrieved to aid a user in identifying whether the data point of interest is an outlier, an anomaly, noise, or belongs to a specific cluster. Once the data points have been labeled, the method returns to operation 222 so that the data may undergo another iteration of the clustering process.

The method illustrated in FIG. 2 may continue until the clustering results are acceptable to a user, such as a subject matter expert familiar with the asset in interest. The cluster results, once approved, may be stored in memory, such as storage subsystem 109, for use in training machine learning models.

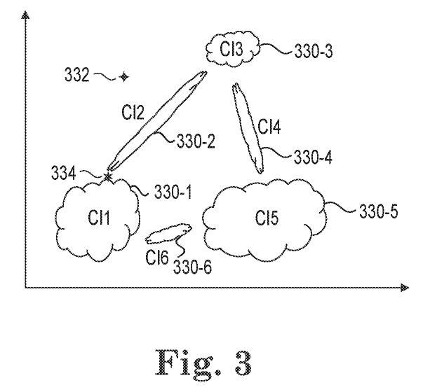

FIG. 3 illustrates a conceptual example of operations related to asset anomaly detection using clustering with feedback in accordance with one or more embodiments. For instance, FIG. 3 may illustrate clustering results associated with a clustering process performed as described in association with FIG. 2.

The clustering results illustrated in FIG. 3, may be displayed to a user for approval, such as in operation 225 of FIG. 2. As illustrated in FIG. 3, asset data is clustered into six different clusters 330-1, 330-2, 330-3, 330-4, 330-5, and 330-6 (which may be collectively referred to as clusters 330). Each cluster is labeled corresponding to which cluster it represents. For example, cluster 330-1 is labeled as “Cl1” and cluster 330-2 is labeled as “Cl2”. The clusters are labeled in no particular order or significance and assigned labels are purely exemplary. As an example, data included in clusters 330-1, 330-3, and 330-5 (e.g., Cl1, Cl3, Cl5) may represent data identified as being associated with normal operational conditions for an asset. Data included in clusters 330-2, 330-4, and 330-6 (e.g., Cl2, Cl4, Cl6) may represent data identified as being associated with a transitional condition. Alternatively, all clusters 330 may represent data associated with normal operational conditions.

As illustrated in FIG. 3, the clustering results may include a data point with no confidence level assigned to it from a previous clustering process, represented by the four-point star 332 as an example. This data point does not belong to any of the six clusters. After examination by a user, this data point may be labeled as an anomaly data point. The six-point star 334 illustrated in FIG. 3 may represent a data point classified into cluster one from a previous clustering process but with a low confidence level as an example. After examination by a user, this data point may be relabeled as belonging to cluster 330-2. A user may retrieve data points collected within a certain time period of a data point of interest to aid in examination. As an example, data collected within 10 minutes of the data point of interest may be retrieved to aid a user in identifying which cluster the data point belongs to, or whether the data point is an anomaly.

The data of clusters 330 may identify the normal operational conditions of one or more assets associated with the clustered data. The clustered data may then be used to train machine learning models.

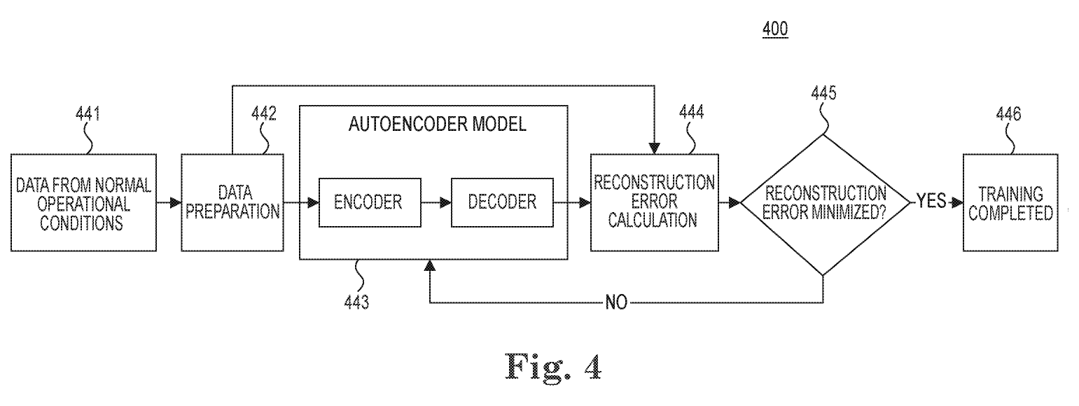

FIG. 4 illustrates a flow diagram of an example method 400 for training a model using a result of clustered asset data with feedback in accordance with one or more embodiments. The clustered asset data may be received from storage subsystem 109, for example, as a result of the clustering process performed in association with FIG. 2. The method 400 of FIG. 4 may be performed by the diagnostic system 107 of FIG. 1, for example.

At operation 441, data from normal operation conditions may be received as input. The data from normal operation conditions may be identified in operation 226 of FIG. 2, as described above. In this regard, the clustered sample data may identify the normal operating conditions of a particular asset. In some embodiments, the clustered data may also identify a type for the asset (e.g., a boiler, a compressor, etc.) as defined, for example, by an asset identifier as described above.

In some embodiments, the clustered data may undergo a data preparation phase at operation 442. The data preparation phase may comprise grouping the clustered data and/or splitting the clustered data into batches for training. In some embodiments, the clustered data may be divided into batches of equal length for training.

The clustered data may then be provided to the autoencoder model 443 for training. The autoencoder model 443 may be a type of artificial neural network used to learn the normal operational behavior of asset(s) in an unsupervised manner. The autoencoder model 443 may include an encoder and a decoder, with one exemplary function of the autoencoder being to learn a representation (e.g., an encoding or compression) for the clustered data, for dimensionality reduction, by training the autoencoder model 443 to ignore signal noise through use of an encoder. In this regard, representing data in a lower-dimensional space can improve performance on different tasks, such as classification. Along with the reduction, a reconstruction is learned (e.g., decoding or decompression), wherein the autoencoder model 443 generates, from the reduced encoding, a reconstructed output. The reconstructed output is a representation intended to be as close as possible to the original input clustered data.

Once the reconstructed output is generated, a reconstruction error is determined (e.g., calculated) at operation 444. The diagnostic system 107 of FIG. 1, for example, such as the training circuitry 111, may be configured to determine a reconstruction error for the clustered data based at least on a compression and a decompression (e.g., the encoding and decoding described above) of the clustered data. In this regard, the determined reconstruction error is used as an evaluation metric. As described above, the autoencoder model 443 can learn what normal operational conditions are for the asset, such that the model can reconstruct the input sequence. In some embodiments, the reconstruction error is a value based on the difference between the original clustered data (e.g., the prepared clustered data 442) and the reconstructed output. In some embodiments, the reconstruction error may be based on an average of determined reconstruction errors for each process variable across different time steps.

At operation 445, the method 400 includes determining whether the reconstruction error is minimized or not minimized (e.g., can be further minimized). For example, if the difference between the reconstruction errors of the current iteration and previous iteration is less than a predefined metric, the error is minimized, and the training is completed at 446. If the difference between the reconstruction errors of the current iteration and previous iteration is more than a predefined metric, the error is not minimized, and the method will proceed to adjust the neural network’s parameters and undergo the operations of autoencoder model 443 for another iteration.

The method 400 may continue until the reconstruction error has been minimized. Once training of the autoencoder model is complete, a trained autoencoder model is obtained and key data features of the normal operational conditions are determined. The trained autoencoder model may then be used for anomaly detection (e.g., to detect an anomaly occurring in the assets).

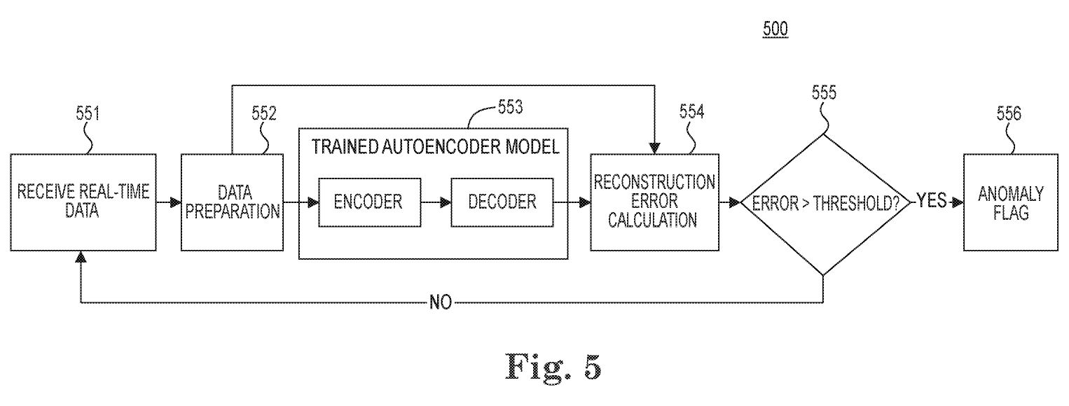

FIG. 5 illustrates a flow diagram of an example method 500 for operating a trained model using a result of clustered asset data with feedback in accordance with one or more embodiments. The method 500 illustrated in FIG. 5 may be performed by the diagnostic system of FIG. 1, for example.

At operation 551, the diagnostic system 107 described in connection with FIG. 1, for example, may receive data associated with an asset. The received data can include real-time data (or near real-time data), such as for example, real-time data received from one or more sensors associated with the asset. For example, the received data can comprise real-time data such that the data is indicative of the current state of the asset and comprise measurements or readings the asset is currently experiencing or producing.

The data may be received (e.g., via network 105) from one or more sensor devices associated with the asset, such as temperature sensors, pressure sensors, oxygen sensors, and/or other types of sensors. In some examples, the data may be received from an intermediary device between the sensors and the diagnostic system 107, such as a computing device associated with and/or embodied by the asset that is configured to monitor and/or control the related sensor devices.

The data may include, for example, values for one or more process level variables determined by the sensors associated with the asset. The data may be data captured from one or more sensors associated with the asset over a specific period of time and at a particular sampling rate, such as, for example, every minute over the previous hour.

In some examples, the data may be received according to a predefined schedule. For example, the diagnostic system 107 may be configured to receive data associated with one or more assets periodically in order to monitor and diagnose the assets accordingly. The data may also comprise an asset identifier as described above, such that an asset type is provided with the received data.

In some embodiments, the data may undergo a data preparation phase at operation 552. The data preparation phase may comprise grouping the data and/or splitting the data into batches. In some embodiments, the data may be divided into batches of equal length.

The data may then be provided to the trained autoencoder model 553 for anomaly detection. Prepared data are then encoded and decoded in the trained autoencoder model 553 to generate the reconstructed data. With the original data received at operation 551 and the reconstructed data, the reconstruction error is determined (e.g., calculated) at operation 554. The diagnostic system 107 of FIG. 1, for example, such as the training circuitry 111, may be configured to determine a reconstruction error for the data based at least on a compression and a decompression (e.g., the encoding and decoding described above) of the data. In this regard, the determined reconstruction error is used as an evaluation metric. As described above, the trained autoencoder model 553 can identify whether an anomaly is present in the received dataset. In some embodiments, the reconstruction error is a value based on the difference between the original data (e.g., the prepared real-time data 552) and the reconstructed output. In some embodiments, the reconstruction error may be based on an average of determined reconstruction errors for each process variable across different time steps.

At operation 555, it is determined whether the reconstruction error is greater than a predefined threshold. If the reconstruction error is greater than a predefined threshold, an anomaly flag is set at operation 556 to indicate the asset has an anomaly. If the reconstruction error is less than the threshold, the operation will return to operation 551 to process the real-time data at the next time interval.

FIG. 6 illustrates a block diagram of an example computing device 603 for asset anomaly detection using clustering with feedback in accordance with one or more embodiments of the present disclosure. Computing device 603 can be, for example, computing device 103 previously described in connection with FIG. 1. As illustrated in FIG. 6, the computing device 603 can include a memory 663 and a processor 662 for asset anomaly detection using clustering with feedback in accordance with the present disclosure.

The memory 663 can be any type of storage medium that can be accessed by the processor 662 to perform various examples of the present disclosure. For example, the memory 663 can be a non-transitory computer readable medium having computer readable instructions (e.g., executable instructions/computer program instructions) stored thereon that are executable by the processor 662 for asset anomaly detection using clustering with feedback in accordance with the present disclosure.

The memory 663 can be volatile or nonvolatile memory. The memory 663 can also be removable (e.g., portable) memory, or non-removable (e.g., internal) memory. For example, the memory 663 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 663 is illustrated as being located within computing device 603, embodiments of the present disclosure are not so limited. For example, memory 663 can also be located internal to another computing resource (e.g., enabling computer readable instructions to be downloaded over the Internet or another wired or wireless connection).

The processor 662 may be a central processing unit (CPU), a semiconductor-based microprocessor, and/or other hardware devices suitable for retrieval and execution of machine-readable instructions stored in the memory 663. The processor 662 may be in communication with the memory 663 via a bus for passing information among components of the computing device 603. The processor 662 may include one or more processing devices configured to perform independently in some embodiments. Alternatively, the processor 662 may include one or more processing devices configured to perform concurrently to execute one or more instructions stored in memory 663.

In some embodiments, the processor 662 may be configured to execute instructions stored in the storage subsystem 109, and/or circuitry otherwise accessible to the processor 662, such as the clustering circuitry 111, training circuitry 113, and/or data evaluation circuitry 115 described in connection with FIG. 1.

The computing device 603 can include input/output circuitry 664 in some embodiments. The input/output circuitry 664 may be in communication with processor 662 to provide an output (e.g., to a user) or receive an indication of an input (e.g., by a user). The input/output circuitry 664 may include a user interface, which may be a display, a web user interface, a mobile application, or a query initiating computing device, in some examples. The input/output circuitry 664 may also include a keyboard, a mouse, a joystick, a touch screen, a microphone, a speaker, or other input/output mechanisms.

The computing device 603 may include communications circuitry 661, in some embodiments of the present disclosure, as illustrated in FIG. 6. The communications circuitry 661 may include circuitry embodied in hardware and/or software that is configured to receive and/or transmit data to/from a network, such as network 105 described in connection with FIG. 1. Communications circuitry 661 may be configured to transmit data to/from other devices, circuitry, or modules in communication with the computing device 603. The communications circuitry 661 may include one or more network interface cards, buses, modems, switches, and/or routers for enabling communications via a network.

The computing device 603 can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that device. Further, while a single computing device is illustrated, the term “computing device” shall also be taken to include any collection of devices that individually or jointly execute a set (or multiple sets) of instructions to perform any one or more of the methodologies discussed herein.

In alternative embodiments, the computing device 603 can be connected (e.g., networked) to other computing devices in a LAN, an intranet, an extranet, and/or the Internet. The computing device can operate in the capacity of a server or a client device in client-server network environment, as a peer device in a peer-to-peer (or distributed) network environment, or as a server or a client device in a cloud computing infrastructure or environment.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving, by a computing device, sample data including a plurality of data points associated with an asset;
generating, by the computing device, a plurality of clusters based on the received sample data according to a plurality of operational conditions associated with the asset;
determining, by the computing device, a confidence level associated with each data point within each cluster of the plurality of clusters;
displaying, by a user interface of the computing device, the plurality of clusters and each data point having a determined confidence level below a predefined threshold;
receiving, via the user interface of the computing device, approval of the plurality of clusters; and
storing, by the computing device, the plurality of clusters in a database upon receiving approval from a user.

2. The method of claim 1, wherein generating the plurality of clusters includes labeling the data points of the sample data according to the operational conditions, wherein the operational conditions are defined according to conditions of the asset.

3. The method of claim 1, wherein the sample data is received from one or more sensor devices associated with the asset.

4. The method of claim 1, wherein the sample data is collected within a particular time period.

5. The method of claim 1, wherein the method further includes:
determining, by the computing device, whether the received sample data includes any data points included in a previously generated cluster; and
generating, by the computing device, the plurality of clusters based only on the data points included in the received sample data not included in the previously generated cluster.

6. The method of claim 1, wherein the method includes generating, by the computing device, the plurality of clusters based on the received sample data according to a plurality of transitional conditions associated with the asset, wherein the transitional conditions include data points collected during a transition period of the asset from one operational condition to another operational condition.

7. The method of claim 1, wherein the method includes:
training, by the computing device, an anomaly detection model using the plurality of clusters; and
detecting, by the computing device, an anomaly occurring in the asset using the trained anomaly detection model.

8. A non-transitory computer readable medium storing instructions executable by a processing resource that when executed, cause the processing resource to:
generate a plurality of clusters based on sample data including a plurality of data points associated with an asset according to a plurality of operational conditions associated with the asset;
determine a confidence level associated with each data point within each cluster of the plurality of clusters;
display the plurality of clusters and each data point having a determined confidence level below a predefined threshold;
receive approval of the plurality of clusters;
train an anomaly detection model using the plurality of clusters in response to receiving the approval; and
detect an anomaly occurring in the asset using the trained anomaly detection model.

9. The non-transitory computer readable medium of claim 8, wherein the sample data includes a plurality of data points associated with a plurality of assets.

10. The non-transitory computer readable medium of claim 8, wherein each cluster of the plurality of clusters corresponds to a normal behavior of the asset.

11. The non-transitory computer readable medium of claim 8, further comprising instructions to regenerate the plurality of clusters in response to approval of the plurality of clusters not being received.

12. The non-transitory computer readable medium of claim 8, wherein each cluster of the plurality of clusters corresponds to a particular operational condition of the plurality of operational conditions.

13. The non-transitory computer readable medium of claim 8, wherein the plurality of clusters are generated using a density-based method.

14. The non-transitory computer readable medium of claim 8, further comprising instructions to determine whether the sample data includes a label associated with each data point within the sample data.

15. The non-transitory computer readable medium of claim 8, further comprising instructions to generate labels associated with each data point within the sample data.

16. A computing device for asset anomaly detection, comprising:
a processing resource; and
a memory resource storing non-transitory machine-readable instructions that when executed, cause the processing resource to:
receive sample data associated with an asset, wherein the sample data includes labeled data points and unlabeled data points;
generate a plurality of clusters based on the labeled data points and the unlabeled data points such that each data point within the generated plurality of clusters is labeled;
determine a confidence level associated with each labeled data point within the generated plurality of clusters;
display, on a user interface of the computing device, the plurality of clusters and each labelled data point having a determined confidence level below a predefined threshold;
receive, via the user interface of the computing device, approval of the plurality of clusters; and
store the plurality of clusters in a database upon receiving approval.

17. The computing device of claim 16, wherein the plurality of clusters are generated according to operational conditions associated with the asset.

18. The computing device of claim 16, wherein the plurality of clusters represent normal behavior of the asset.

19. The computing device of claim 16, wherein the plurality of clusters are generated using an unsupervised clustering method.

20. The computing device of claim 16, wherein the instructions further cause the processing resource to train a machine learning model using the stored plurality of clusters to determine whether an anomaly is present in operating data associated with the asset.
